(19) United States
(12) Patent Application Publication
(10) Pub. No.: US 2006/0159009 A1
(43) Pub. Date: Jul. 20, 2006

(54) Fast rerouting apparatus and method for MPLS multicast

(76) Inventors: Jin-Hyoung Kim, Suwon-si (KR); Byung-Chang Kang, Yongin-si (KR); Yong-Seok Park, Seongnam-si (KR)

Correspondence Address: ROBERT E. BUSHNELL, 1522 K STREET NW, SUITE 300, WASHINGTON, DC, 20005-1202, US

(21) Appl. No.: 11/331,076

(22) Filed: Jan. 13, 2006

(30) Foreign Application Priority Data
Jan. 14, 2005 (KR) 10-2005-0003888

(51) Int. Cl. H04J 1/16; H04J 3/14; H04L 12/56; H04L 12/28

(52) U.S. Cl. 370/216; 370/242; 370/389

(57) ABSTRACT

Disclosed is a fast rerouting apparatus and method for multiprotocol label switching (MPLS) multicast. The fast rerouting apparatus and method is to rapidly cope with a failure occurring on an MPLS network. The fast rerouting method of redirecting a packet to be transmitted at the nearest location from a location where the failure occurs is applied to the MPLS multicast, so that it is possible to rapidly cope with the failure generated when an MPLS multicast packet is transmitted.

### CLAIM OF PRIORITY

This application makes reference to, incorporates the same herein, and claims all benefits accruing under 35 U.S.C. §119 from an application for FAST REROUTING APPARATUS AND METHOD FOR MPLS MULTICAST earlier filed in the Korean Intellectual Property Office on Jan. 14, 2005 and there duly assigned Ser. No. 10-2005-0003888.

### BACKGROUND OF THE INVENTION

1. Field of the Invention

The present invention relates generally to technology for rapidly restoring a failure occurring on a multiprotocol label switching (MPLS) network, and more particularly to a fast rerouting apparatus and method of an MPLS multicast packet for rapidly coping with a failure generated when the MPLS multicast packet is transmitted.

2. Description of the Related Art

In general, an MPLS network simplifies transmission of a packet by transmitting the packet having a short length of label through a path called a label switched path (LSP), and makes it possible to control a traffic flow through traffic engineering. See Network Working Group Request for Comments (RFC) 3031.

A fundamental concept in MPLS is that two Label Switching Routers (LSRs) must agree on the meaning of the labels used to forward traffic between and through them. This common understanding is achieved by using a set of procedures, called a label distribution protocol (LDP, see RFC 3036), by which one LSR informs another of label bindings it has made.

The LSP is established at its edge LSR (called “MPLS Edge Switch, or Label Edge Router (LER), and hereinafter referred to as “router”). A failure that occurs on a network is restored by establishing a new LSP to replace the LSP where the failure occurs at the router and then transmitting a packet to be transmitted through the LSP where the failure occurs through the newly established LSP. However, this method is subjected to delay of a message for establishing the new LSP, thus having a great packet loss and a low transmission speed. Particularly, this causes trouble for real-time service, such as VoIP (Voice over IP) etc., which must redirect traffic to a backup LSP within a short time. It is fast rerouting that is introduced in order to solve this problem. In other words, the fast rerouting is proposed in consideration that requirements of the real-time service will be satisfied. Of course, the fast rerouting can be applied to all networks inclusive of the network providing the real-time service.

The fast rerouting sets up the backup LSP before any failure occurs, and when the failure occurs on a network, redirects a packet to the closest location from a location where the failure occurs. In this manner, the fast rerouting is a technique capable of rapidly coping with the network failure. At this time, the closest location from the location where the failure occurs, i.e. the location redirecting the packet, generally, is a node just prior to a node where the failure occurs.

However, the current fast rerouting can be applied only to the MPLS for MPLS unicast employing a point-to-point LSP, but is not developed for MPLS multicast. Thus, a new fast rerouting apparatus and method for the MPLS multicast employing a point-to-multipoint LSP is required.

### SUMMARY OF THE INVENTION

It is, therefore, an objective of the present invention to provide a fast rerouting apparatus and method applied to MPLS multicast.

In order to accomplish the objective, according to an aspect of the present invention, there is provided a fast rerouting apparatus for MPLS multicast. The fast rerouting apparatus comprises: a message sender for sending and receiving a message to and from an upstream or downstream node; a message processor for, when a path requested for routing through a routing request message from the upstream node is a path to perform fast rerouting, sending a routing request message for establishing a next hop database (NHDB) to the downstream node through the message sender, and establishing the NHDB using information included in a response message received from the downstream node; and a storage for storing the established NHDB.

According to another aspect of the present invention, there is provided a protocol for fast rerouting for MPLS multicast. The protocol comprises: a Next Hop object including information for establishing a next hop database (NHDB) used when a path for the fast rerouting of the MPLS multicast is established; a Next-Next Hop object including information for establishing the NHDB; and a Unicast Backup LSP (Label Switched Path) Request object requesting another node of a corresponding multicast tree to set up a unicast backup path.

According to yet another aspect of the present invention, there is provided a fast rerouting apparatus for MPLS multicast on a MPLS network where a replacement path for fast rerouting for the MPLS multicast is established using a next hop database (NHDB). The fast rerouting apparatus comprises: a message sender for sending and receiving a message to and from an upstream and downstream node; a failure detector for determining whether a failure occurs between the downstream node and another node or not; a path computer for searching for a replacement node of the node where the failure occurs; and a packet processor for determining whether a multicast packet received from the upstream node is a packet which must be transmitted through both the path where the failure occurs and the replacement path, and when the multicast packet must be transmitted through both of the paths, transmitting the multicast packet to a next branch node in a multicast packet format, and setting up a unicast backup path from the next branch node to a destination node of the packet.

According to still yet another aspect of the present invention, there is provided a fast rerouting method for MPLS multicast, comprising: a first step of receiving information for establishing a next hop database (NHDB) used for fast rerouting on a network from a downstream node; a second step of establishing the NHDB using the received information; and a third step of establishing a path for the fast rerouting for the MPLS multicast using the established NHDB.

According to still yet another aspect of the present invention, there is provided a fast rerouting method for MPLS multicast on a network where a backup path for fast rerouting for the MPLS multicast used is established using a next hop database (NHDB). The fast rerouting method comprises: a first step of detecting generation of a failure on a protected path; a second step of searching the backup path of the protected path where the failure occurs; a third step of determining whether the backup path belongs to existing transmission path of a multicast packet received from an upstream node or not; and a fourth step of transmitting the multicast packet to a next branch node on the backup path belonging to the existing transmission path in a multicast packet format, and requesting the branch node to establish a unicast backup path from the branch node to an end node of the backup node.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 shows a configuration of a network to which fast rerouting can be applied;

FIG. 2 is a format of a FAST_REROUTE object used for setup of a backup LSP (Label-Switched Path) for fast rerouting;

FIG. 3 shows a signaling process of setting up an LSP and a backup LSP in order to perform fast rerouting;

FIG. 4 shows distribution of labels for MPLS fast rerouting;

FIG. 5 shows transmission of a packet on a network to which the MPLS fast rerouting as in FIGS. 2 and 3 can be applied;

FIG. 6 shows a signaling process for MPLS multicast;

FIG. 7 shows transmission of an MPLS multicast packet;

FIG. 8 shows fast rerouting for MPLS multicast employing fast rerouting of MPLS unicast;

FIG. 9 shows a format of a Next Hop object of a signaling protocol according to the present invention;

FIG. 10 shows a format of a Next-Next Hop object of a signaling protocol according to the present invention;

FIG. 11 is a format of a Unicast Backup LSP Request object of a signaling protocol according to the present invention;

FIG. 12 shows a configuration of an NHDB (next hop database):

FIG. 13 shows use of Next Hop and Next-Next Hop objects for setting up an MPLS multicast LSP;

FIG. 14 shows setup of a backup LSP of MPLS multicast; and

FIG. 15 shows transmission of an MPLS multicast packet to which fast rerouting is applied, wherein the transmission is performed through the backup LSP set up in FIG. 14.

### DETAILED DESCRIPTION OF THE INVENTION

Hereinafter, exemplary embodiments of the present invention are described in detail with reference to the accompanying drawings. Detailed description of known functions or configurations incorporated herein or illustrated in the drawings are omitted if it may unnecessarily obscure the subject matter of the present invention.

The present invention to be described below is adapted to extend fast rerouting applied to MPLS (Multi-Protocol Label Switching) unicast to thereby be applied to MPLS multicast. In order to help understanding the present invention, description will be made about the fast rerouting applied to the MPLS unicast first.

The fast rerouting can be accomplished by establishing an LSP (Label Switched Path) and a backup LSP by using an expanded RSVP-TE (Resource Reservation Protocol-Traffic Engineering) protocol for making a request for the fast rerouting, and by redirecting a packet to the established backup LSP in the event of a network failure.

For the MPLS fast rerouting, the backup LSP is established at a position where an original LSP can be branched off in order to protect any link or node at which a failure may occur. The original LSP is called “protected LSP,” and the LSP established for use as a rerouting path is called “backup path.” The MPLS fast rerouting makes use of an MPLS label stack, and the backup LSP may cross the protected LSP.

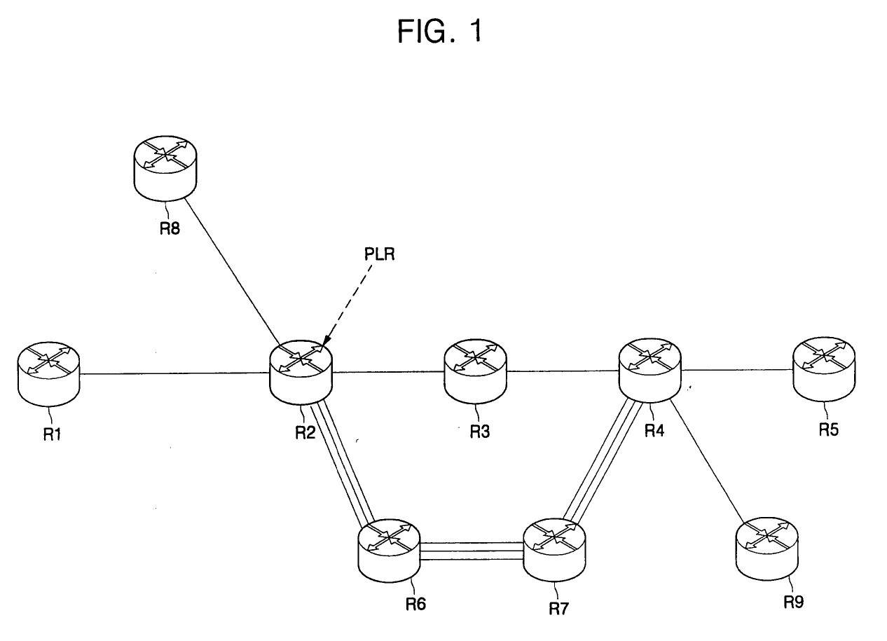

FIG. 1 shows a configuration of a network to which fast rerouting can be applied.

As shown in FIG. 1, the fast rerouting can be applied to a network having at least one node. Here, the nodes are a variety of network components such as a switch, a router etc. Hereinafter, the present invention will be described taking the router as an example of the node. In FIG. 1, R1 to R9 stand for the routers. Ifnot separately shown in the figure, each of the routers may include a message sender for sending and receiving a message to and from any other router connected through a link, and a message processor for analyzing and processing the received message. Each of the routers may further include a storage for storing information on a path for sending traffic, and so on. Alternatively, each of the routers may include a path computer for computing and setting the path for sending the traffic. These components of each router may be used by modification into a form helpful to the present invention.

On the basis of an arbitrary router in the network as shown in FIG. 1, a router sending a packet to the reference router is called “upstream router,” and router receiving a packet from the reference router is called “downstream router.” The reference router may send a response message to the upstream router in response to the message received from the upstream router, and may receive a response message from the downstream router in response to the message which the reference router itself has sent to the downstream router.

In FIG. 1, suppose that the LSP connecting R2, R3 and R4 is the protected LSP, and that the LSP connecting R2, R6, R7 and R4 is the backup LSP. The LSP connecting R2, R6, R7 and R4 can be used as a detour LSP when a failure occurs at the LSP connecting R2, R3 and R4. When a failure occurs between R2 and R3, R2 sends a packet, which is to be sent through R3, to R6 in order to send it through the backup LSP. At this time, R2 allocates an Inbound label allocated by R4 of the protected LSP and pushes a label for the backup LSP. For instance, when penultimate-hop popping is used, R4 receives the inbound label for the protected LSP from R7. In FIG. 1, R2 serves as PLR (Point to Local Repair), and R4 serves as MP (Merge Point). In FIG. 1, all the LSPs from R1, R2 or R8 to R4, R5 or R9 share one backup LSP, so that it is possible to provide scalability.

On the other hand, this establishment of the path may be performed by using an extended resource reservation protocol with traffic engineering (RSVP-TE). Hereinafter, description will be made about extension of an RSVP-TE signaling protocol for requesting the fast rerouting.

A label edge router (LER) uses an extended object to make a request for establishment of the backup LSP.

A FAST_REROUTE object is an object used to provide information for setting up the backup LSP. The FAST_REROUTE object should be inserted when a Path message is sent, and should not be changed on the downstream LSP. The Path message is a path setup message requesting setup of the LSP on the network.

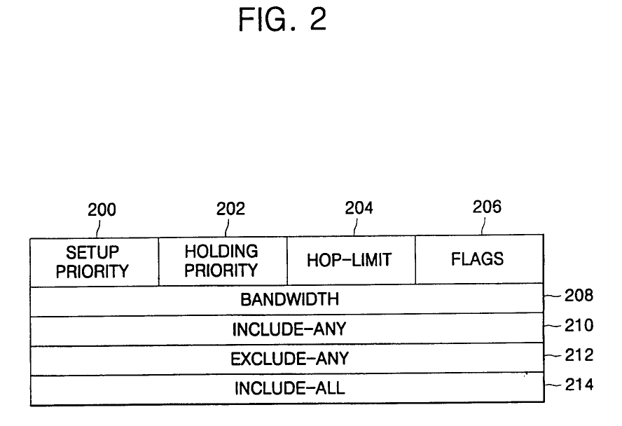

FIG. 2 is a format of a FAST_REROUTE object used for setup of a backup LSP for fast rerouting.

The following description is made regarding flags associated directly with the present invention with reference to FIG. 2. A Setup Priority field 200 contains a value representing priority of a backup LSP. This value is for deciding whether the backup LSP can preempt another LSP by comparison of the priority of the backup LSP and that of another LSP. A Holding Priority field 202 contains a value representing holding priority of a backup LSP. This value is for deciding whether the backup LSP can be preempted by another LSP by comparison of the priority of the backup LSP and that of another LSP. A Hop-limit field 204 contains a value representing the maximum number of hops allowable for setup of a backup LSP. A Flags field 206 contains a value indicating a type of a backup LSP desired. For example, if the value of the Flags filed is set to “0x01,” 1:1 backup LSP is desired. If set to “0x02,” N:1 backup LSP is desired. A Bandwidth field 208 contains a bandwidth desired value of a backup LSP. An Include-any field 210 includes a 32-bit vector value having information on a link which any detour must render acceptable in order to set up the backup LSP. An Exclude-any field 212 contains a 32-bit vector value having information on a link which any detour must render unacceptable in order to set up the backup LSP. An Include-all field 214 contains a 32-bit vector value having information on a link which all detours must render acceptable in order to set up the backup LSP.

Further, a SESSION_ATTRIBUTE object and a RECORD_ROUTE object IPv4/IPv6 sub-object each add two flags to a flag defined for an existing RSVP-TE for the sake of the fast rerouting.

The SESSION_ATTRIBUTE object further includes a Bandwidth-protection-desired flag that desires to guarantee the bandwidth of the backup LSP and a Note-protection-desired flag that desires the PLR (Point to Local Repair) to protect the next router of the protected LSP. The Bandwidth-protection-desired flag may be set to a value of “0x08,” and the Note-protection-desired flag may be set to a value of “0x10,” so as to desire the PLR to protect the next router of the protected LSP.

The RECORD_ROUTE object IPv4/IPv6 sub-object further include a Bandwidth-protection flag that the PLS sets up when the bandwidth of the backup LSP is set to be guaranteed, and a Note-protection flag that the PLR sets up when the backup LSP is established in order to protect failure of the next router. The Bandwidth-protection flag may be set to a value of “0x04,” and the Note-protection flag may be set to a value of “0x08.”

The following description will be made regarding how an LSP and a backup LSP based on an extended RSVP-TE signal protocol as mentioned above are set up.

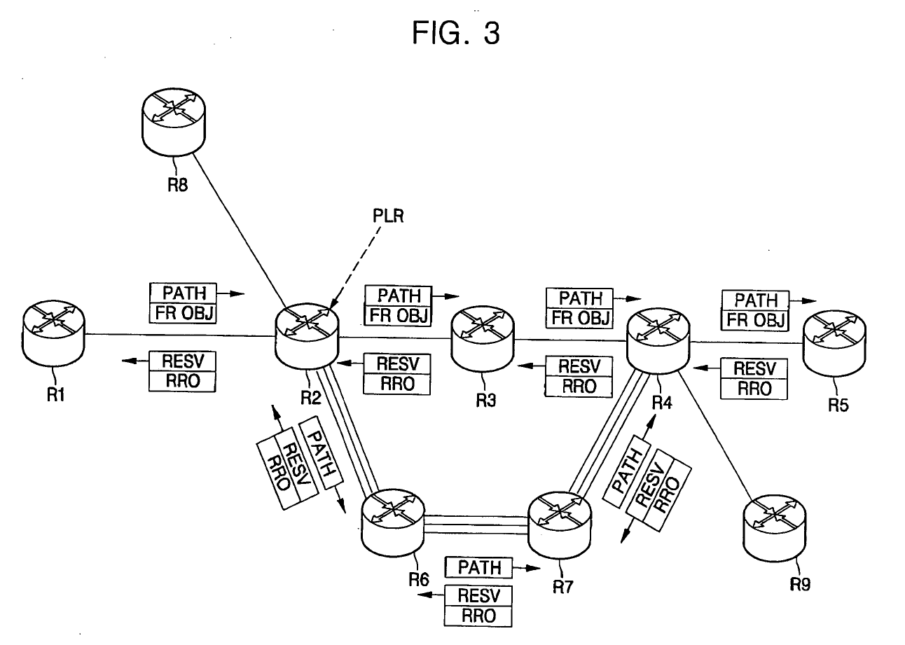

FIG. 3 shows a signaling process of setting up an LSP and a backup LSP in order to perform fast rerouting.

When setting up an LSP for fast rerouting, an LER (Label edge router) encapsulates a FAST_REROUTE object in a Path message, and sets a Local-protection-desired flag within a SESSION_ATTRIBUTE object. Further, the FAST_REROUTE object must be encapsulated in a Path-refresh message. The LER sets a Label-recording-desired flag within the SESSION_ATTRIBUTE object as well. Information required for the backup LSP (e.g. bandwidth, hop limits, etc.) is set by the LER.

A PLR sets up the backup LSP when a setup request is received. At this time, an MP (merge point) may be previously defined or be checked by an RRO (Rate & Route Operator) of the RSVP-TE. When intending to protect its next link, the PLR desires the next downstream router to set up the backup LSP with reference to the RRO. When intending to protect its next router, the PLR sets up the backup LSP to a router that is present in a second RRO with reference to the RRO. The PLR must learn a value of Inbound label allocated at a packet to the MP along a protected LSP. If the MP uses a global label space, this value allows the PLR to learn this value using the RRO of the protected LSP without any explicit signal along the backup LSP. When the backup LSP is set up, the PLR makes use of, as an IPv4 tunnel sender address of a SENDER_TEMPLATE object, an arbitrary address that belongs to the PLR and is not used in the protected LSP. A destination address of the backup LSP will be an address of the MP.

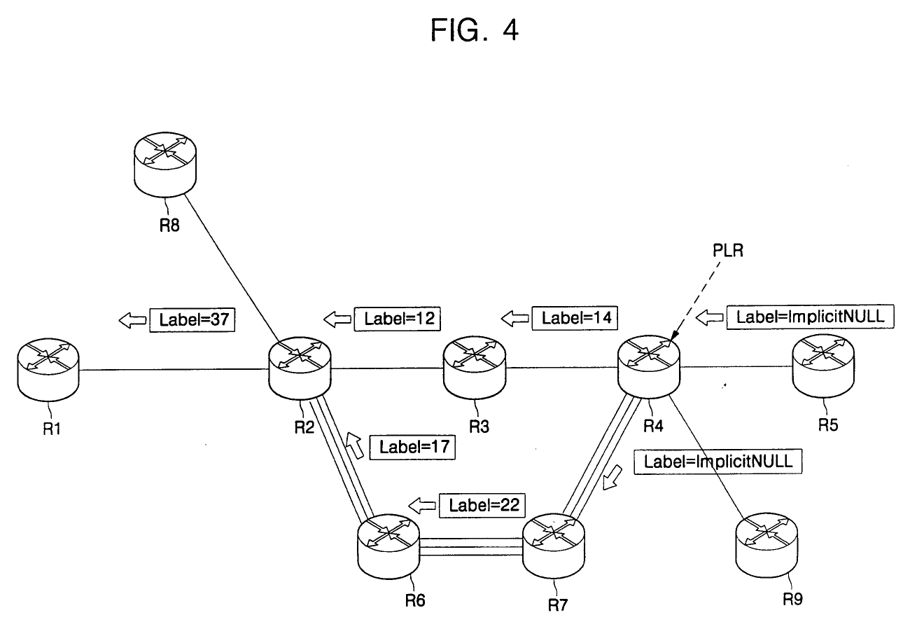

FIG. 4 shows distribution of labels for MPLS fast rerouting.

In FIG. 4, labels for a protected LSP are defined as 37, 12, 14 and Pop, and labels for a backup LSP are defined as 17, 22 and Pop. Packets are transmitted on the network using the labels. On one hand, in FIG. 4, the label is transmitted along R4→R3→R2, or R4→R7→R6→R2, and thus R4 serves as a PLR.

The following description will be made regarding a process of redirecting a packet to a backup LSP when a failure occurs at a network.

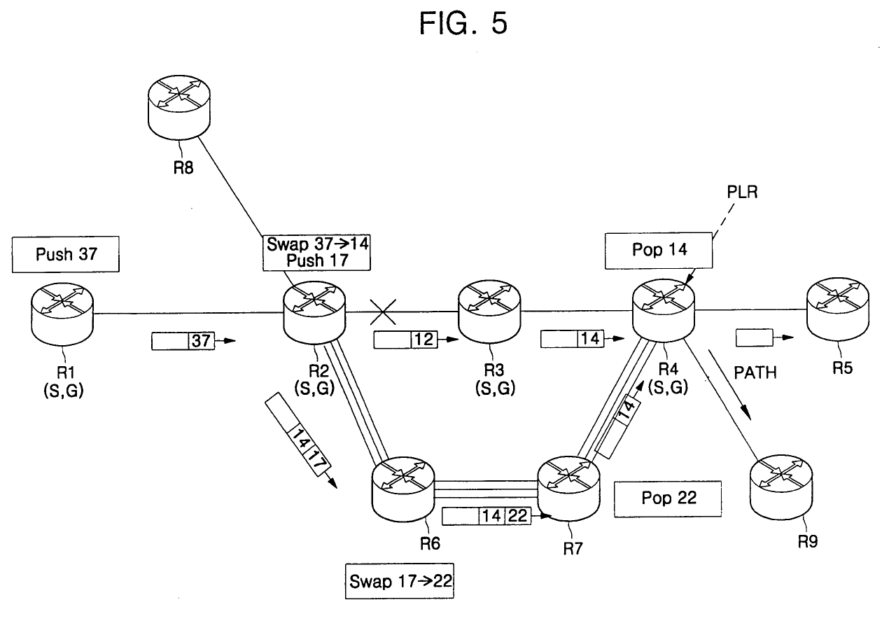

FIG. 5 shows transmission of a packet on a network to which the MPLS fast rerouting as in FIGS. 2 and 3 can be applied.

FIG. 5 shows a process where R2 transmits a packet through a backup LSP, particularly when a failure occurs at a link between R2 and R3. R2 transmits a packet to R4 rather than R3 through a backup LSP (a.k.a., a bypass tunnel). When a failure does not occur, R2 will switch traffic received from R1 and transmit a packet, which is received from R1 into a label 12, and then R3 transmits the packet to R4 after it changes the label 12 of the packet into a label 14. In contrast, when a failure occurs, R2 transmits the packet, which is received from R1, to R6 after it changes a label 37 of the packet into a label 14 and pushes label 17. That is, the label 37 will be swapped for one which will be understood by R4 to indicate the protected LSP, and the bypass tunnel's label will then be pushed onto a label-stack of the redirected packets. Here, it swaps a label 37 of the packet into a label 14 which will be understood by R4, and pushes the bypass tunnel's label 17 and transmits the packet to R6. R6 swaps label 17 for label 22 to transmit the packet to the next node in the protected LSP, router R7. If penultimate-hop-popping is used, R7 transmits a packet, that is received from R6, to the merge point, R4, after it pops the label 22 from the packet. In other words, while being transmitted through the backup LSP, the packet includes the label 14 that is a label of a merge point (MP), thus R4, will receive the redirected packet with a label indicating the path that the packet is to follow. If penultimate-hop-popping is not used, R4 will pop the bypass tunnel's label and examine the label underneath to determine the path that the packet is to follow. In multicast S,G, the symbol “S” denotes a source and “G” denotes a group

Meanwhile, suppose that this fast rerouting applied to MPLS unicast is applied to MPLS multicast.

First, a general MPLS multicast will be described with reference to attached figures.

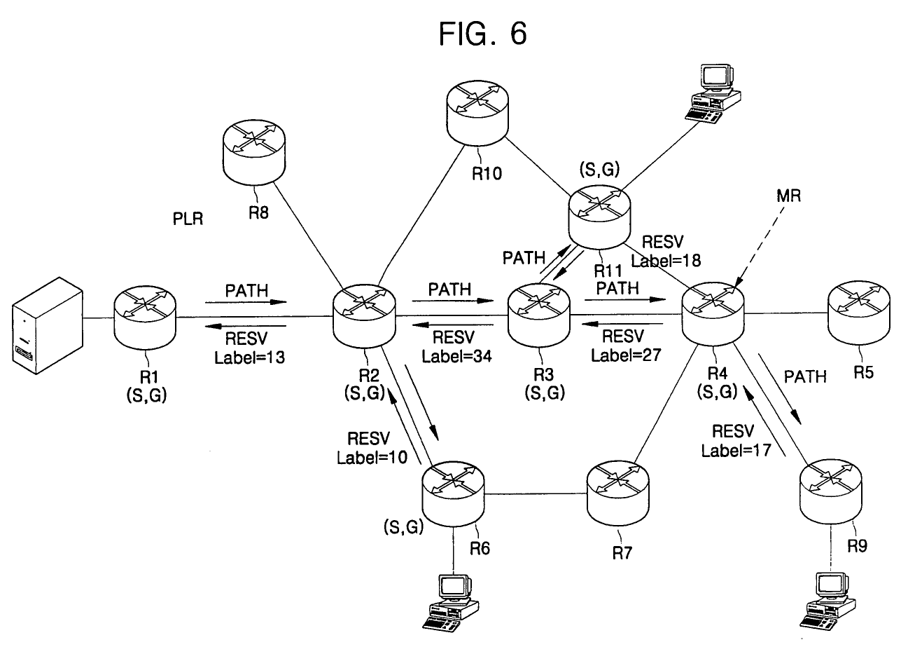

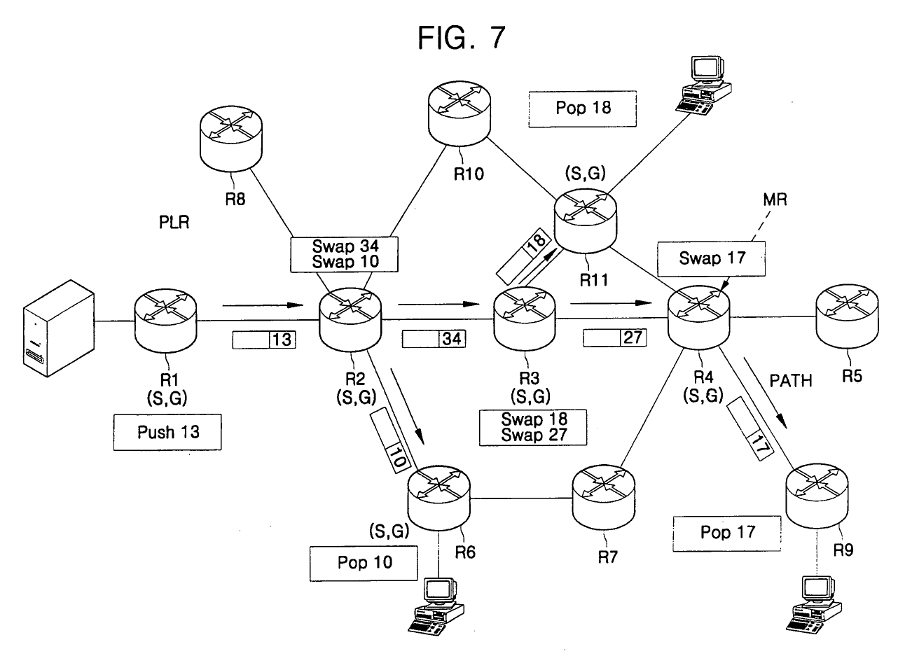

FIG. 6 shows a signaling process for MPLS multicast, and FIG. 7 shows transmission of an MPLS multicast packet.

In MPLS multicast, a Path message should be replicated at a branch router where one or more downstream routers join a multicast group (tree) and then transmitted to a corresponding router, and a Resv message should be merged at the branch router and then transmitted to an upstream router.

When an MPLS multicast packet is received, the MPLS multicast packet is subjected to label operation with reference to a multicast label transmission table and then transmitted to the next router. The MPLS multicast packet must be replicated at the branch router and transmitted to all the routers for which an MPLS multicast LSP is set. In FIG. 6, when a packet with a label 13 is received from R1, R2 changes the label 13 into a label 34 and then transmits the packet to R3, and at the same time R2 changes the label 13 into a label 10 and then transmits the packet to R6.

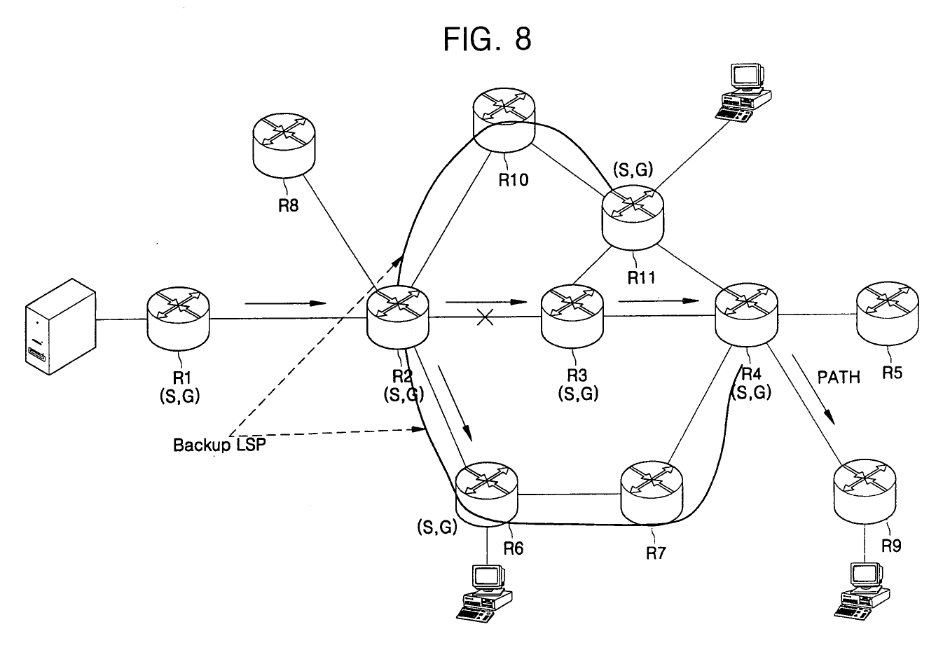

As a method for fast reroute of this MPLS multicast, a method of applying fast reroute of MPLS unicast may be taken into consideration first. However, if the fast reroute of MPLS unicast is applied to this MPLS multicast, there occurs a case that the same packet is transmitted two or more times at some paths. This problem is shown in FIG. 8.

FIG. 8 shows fast rerouting for MPLS multicast employing fast rerouting for MPLS unicast.

In FIG. 8, in order to cope with a link failure between R2 and R3 and a router failure of R3, a unicast LSP is set up from R4 to R11, and an MPLS multicast packet is transmitted to the unicast LSP when the failure occurs. In this case, the MPLS packet is transmitted twice at the path for R2-R6. Further, an RRO (Rate & Route Operator) must be supported in order to support unicast fast reroute. However, in MPLS multicast, how to support the RRO is not determined at a branch router, and because the RRO is received from many sub-trees, many RROs may be transmitted. Hence, a Resv message may be increased in size, which results in a problematic signal protocol.

Thus, for the sake of efficient fast reroute of MPLS multicast, the MPLS multicast packet must be transmitted at the path for R2-R3, and the unicast LSP must be set up at R6 rather than a PLR, R2.

Hereinafter, the fast reroute of MPLS multicast will be described, wherein a packet is transmitted at the path for R2-R6 in a multicast packet format, and through the unicast LSP at the path subsequent to R6.

The fast reroute of MPLS multicast is performed by the use of a next hop database (NHDB). Information required for establishment of the NHDB can be collected using an extended RSVP-TE protocol for the fast reroute of MPLS multicast.

In this manner, the fast reroute of MPLS multicast is performed by an extended signaling protocol, establishment of the NHDB employing the extended signaling protocol, and setup of a backup LSP employing the NHDB. After description of them, how to transmit the MPLS multicast packet on a network to which the fast reroute of MPLS multicast is applied will be described.

First, extension of a signaling protocol for the fast reroute of MPLS multicast will be described. Meanwhile, it should be previously noted that the present invention will be described below by taking an embodiment where a RSVP-TE protocol is used as a signaling protocol by way of an example. Hence, the present invention is not limited to this embodiment, but may be performed using another protocol adapted to perform the same function as the protocol used in the present invention.

Particularly, objects of the RSVP-TE protocol used for the present invention may include a Next Hop object, a Next-Next Hop object and a Unicast Backup LSP Request object. Among them, the Next Hop object and the Next-Next Hop object are used for establishing a NHDB, and the Unicast Backup LSP Request object is used when another router of a multicast tree is requested to set up a unicast LSP. Of course, other objects of the RSVP-TE protocol may be used for the present invention, but the same objects as the existing ones will be no longer described.

First, the Next Hop object will be described.

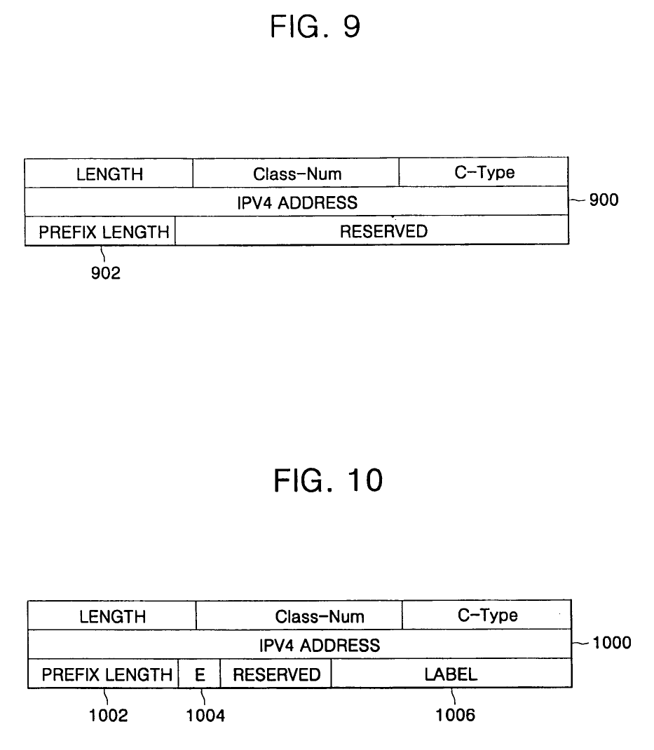

FIG. 9 shows a format of a Next Hop object of a signaling protocol according to the present invention.

A Next Hop object shown in FIG. 9 is used to obtain interface address information from a neighboring downstream router. The Next Hop object includes information 900 on an IPv4 address of the next router, and information 902 on a prefix length of the IPv4 address.

Next, a Next-Next Hop object will be described.

FIG. 10 shows a format of a Next-Next Hop object of a signaling protocol according to the present invention.

A Next-Next Hop object shown in FIG. 10 is used to notify information of a downstream router participating in establishing a point-to-multipoint LSP for an upstream router. The Next-Next Hop object includes information 1000 on an IPv4 address of the next-next router, and information 1002 on a prefix length of the IPv4 address. Further, the Next-Next Hop object further includes information 1004 on E representing whether a next-next node is a host or not. For example, if the E information 1004 has a value of “1,” the next-next node may be set to represent the host. Of course, this value is illustrated to help understand the present invention, but the present invention is not limited due to this specific numerical value. If the next-next node is the host, other fields of the Next-Next Hop object will not be set. Further, the Next-Next Hop object further includes information 1006 on a label that is allocated to a corresponding multicast group by the next-next node. Meanwhile, the Next Hop object of FIG. 9 and the Next-Next Hop object of FIG. 10 may have the same format except a C-type.

Next, the Unicast Backup LSP Request object will be described.

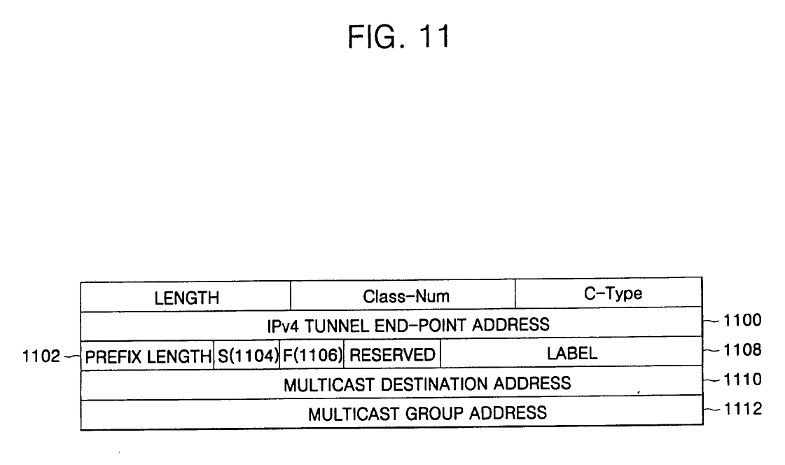

FIG. 11 shows a format of a Unicast Backup LSP Request object of a signaling protocol according to the present invention.

As described above, the Unicast Backup LSP Request object is used when another router of a multicast tree is requested to set a unicast LSP. Here, the multicast tree refers to paths used to transmit a multicast packet to hosts belonging to the multicast group.

As shown in FIG. 11, the Unicast Backup LSP Request object includes information 1100 on an IPv4 tunnel end point address, information 1102 on a prefix length of the IPv4 tunnel end point address, information 1104 on S representing whether a multicast source address is set or not, information 1106 on a flag F requesting to transmit a packet to a backup LSP, information 1108 on a label allocated to a corresponding group address at an end point, information 1110 on a multicast source address for transmission to a tunnel, and information 1112 on a multicast group address for transmission to a tunnel. Here, the tunnel is to be set for the LSP.

Meanwhile, in the description on the objects, each of the objects includes the IPv4 address information, which is responsible for assumption that the present invention is performed on an IPv4 network. If the present invention is performed on any network having an address system other than the IPv4 network, the objects may include network address information on the basis of the address system of a corresponding network.

The establishment of the NHDB employing a signaling protocol having the above-mentioned Next Hop and Next-Next Hop objects in accordance with the present invention will be described.

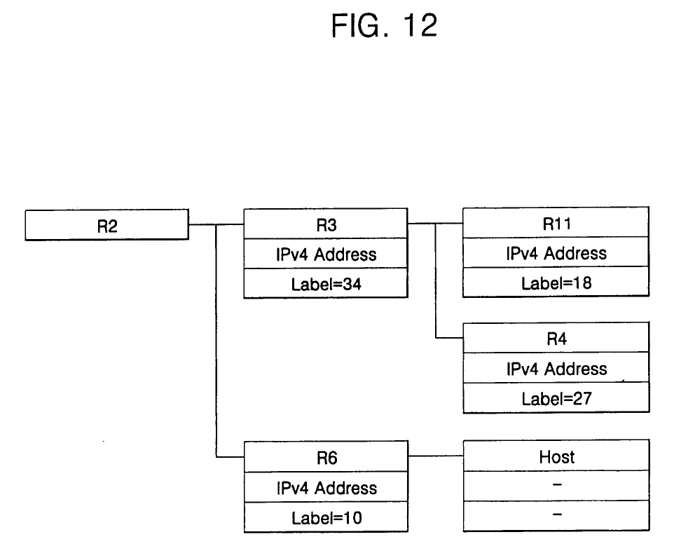

FIG. 12 shows a configuration of an NHDB (next hop database).

As shown in FIG. 12, an NHDB can be understood as a tree form, containing IPv4 address and label information of next and next-next routers to be connected. Of course, this is simply provided to help understand the NHDB, and a type stored in the NHDB may be appropriately selected according to a characteristic of each system.

The NHDB of FIG. 12 is for R2. The NHDB of FIG. 12 will be described below with reference to the configuration of the networks of FIGS. 1 to 8. As shown in FIGS. 1 to 8, and in particular, FIGS. 6 to 8, the next routers connected to R2 are R3 and R6, and R11 and R4 are the next-next routers of R2 and are connected to R2 via R3. The NHDB includes IPv4 address and label information of each of the routers. Of course, R10 may be considered as a next router of R2, but the present invention will be described by taking an embodiment where only R3 and R6 are the next routers of R2 by way of an example.

In establishment of the NHDB, R2 can obtain the IPv4 address and label of R3 or R6 using a Label object and a Next Hop object within a RSVP Resv message received from the downstream router. Further, R2 can obtain the iPv4 address and label of R11 or R4 using the Next-Next Hop object.

Now, setup of the backup LSP using the NHDB of FIG. 12 will be described.

Routing information which is used for the setup of the backup LSP and routed up to an IPv4 address obtained from the NHDB can be obtained using a CSPF (Constraint-based Shortest Path First) based on unicast routing information. Of course, this routing information may be obtained using a variety of routing protocols, each of which will not be separately described.

Under the assumption that a protected LSP is R2-R3-R4, the setup of the backup LSP for the protected LSP using the NHDB will be described with reference to FIG. 8. Here, suppose that all the links of FIG. 8 have the same metric value. First, on computing the shortest route from R2 to R4 without passing though R3, two routes, R2→R0→R11→R4, and R2→R6→R7→R4, will be found. Referring to the NHDB, a route that is most similar to the NHDB among the two computed routes is R2→R6→R7→R4. Thus, unicast information routed to R4 is sent using a route passing through R6. For this reason, R2 makes a request for the setup of the backup LSP through R6. When R2 requests R6 to set up the backup LSP, R2 sends a message containing a Unicast Backup LSP Request object.

Meanwhile, taking a route from R2 to R11 into consideration, the shortest route from R2 to R11 without passing through R3 is R2→R10→R11, but no route corresponding to the shortest route is present in the NHDB. As such, in order to transmit packets to R11, a method of setting up an existing unicast LSP is used.

Such a process of setting up an existing unicast LSP is performed at each router. When requested to set up the unicast backup LSP, R6 selects ERs (Explicit Routes) to set up the unicast backup LSP with reference to the NHDB. At this time, a Path message is sent to any one of the ERs, i.e., the route that is most similar to the NHDB.

Hereinafter, a description will be made regarding processes of setting up an MPLS multicast LSP and a backup LSP for fast reroute of MPLS multicast in accordance with the present invention.

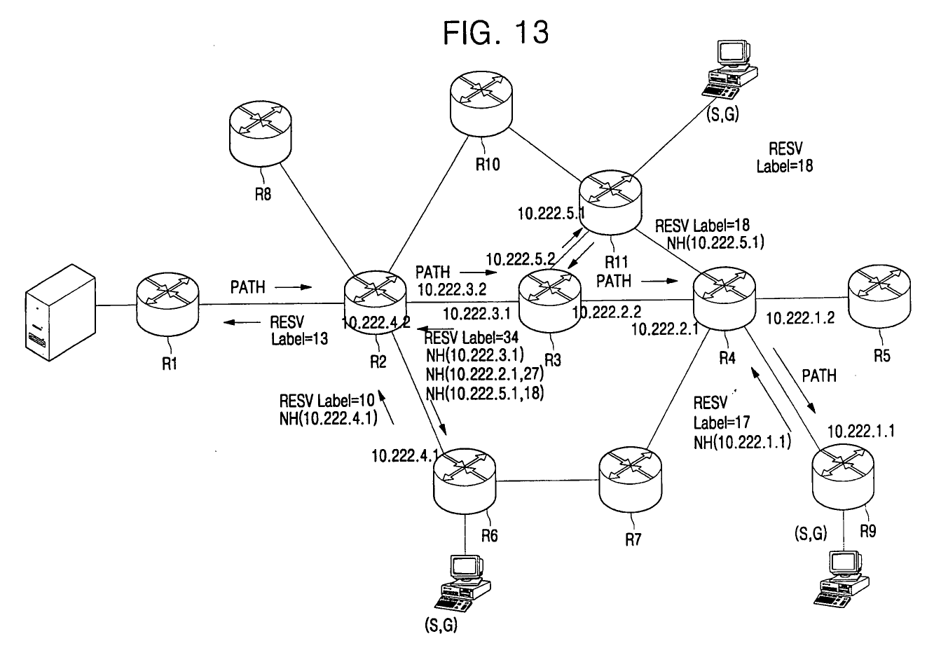

FIG. 13 shows use of Next Hop and Next-Next Hop objects for setting up an MPLS multicast LSP.

Next Hop and Next-Next Hop objects can be transmitted from a downstream router to an upstream router after they are included in an Resv message.

When R1, an LER, sets up an LSP for setup of a backup LSP for fast rerouting, R1 causes a FAST_REROUTE object to be included in a Path message for such a setup and sets a corresponding flag within a SESSION_ATTRIBUTE object. A field within the FAST_REROUTE object and a flag within SESSION_ATTRIBUTE object may be set in the same method as a unicast LSP.

When R2, a PLR, receives the Path message including the FAST_REROUTE object from R1, R2 recognizes the LSP requested by the corresponding Path message to be an LSP required for setup of the backup LSP. In other words, when R2 generates information on a session of the corresponding LSP within a router, R2 stores information indicating the need to set up a backup LSP for a corresponding LSP. R2 transmits the corresponding Path message to a protected LSP without any change with reference to a multicast routing table.

When R3, a downstream router receiving the Path message, transmits a Resv message to R2, R3 generates Next Hop and Next-Next Hop objects to transmit them to R2, an upstream router. The Next Hop object is generated using an IPv4 address of the corresponding router, and the Next-Next Hop router is generated using the Next Hop object and a Label Mapping message which are received from a downstream router of the corresponding router. If there are a plurality of downstream routers, the Next Hop object is generated as many as the number of downstream routers. Specifically, in FIG. 8, R3 generates the Next-Next Hop object including information of R11 and the Next-Next Hop object including information of R4, and then transmits the two Next-Next Hop objects to R2. These Next-Next Hop objects are generated using the Next Hop object and the Label object which are received from R11 and R4. R3 transmits the Next Hop object, which is received from R11 or R4, to R2 as the Next-Next Hop object. However, R3 does not transmit the Next-Next Hop object, which is received from R11 or R4, to R2, but simply makes use of the Next-Next Hop object in order to establish its own NHDB.

R2 receiving the Next Hop object and the Next-Next Hop object from R3 establishes its own NHDB using these Hop objects. In this manner, the establishment of the NHDB using the Next Hop and Next-Next Hop objects received from the downstream router can be equally performed at routers other than R2.

When R2 receives a Resv message containing the Next Hop and Next-Next Hop objects from R3, R2 checks whether the corresponding LSP is one requested for fast rerouting or not with reference to session information of the corresponding LSP.

Failures which may occur on a network may include a link failure and a router failure. If the corresponding LSP is one requested for setup of the backup LSP for coping with the link failure, the backup LSP of the corresponding LSP is established to an IPv4 address of the Next Hop object. If the corresponding LSP is one requested for setup of the backup LSP for coping with the router failure, the backup LSP of the corresponding LSP is established to an IPv4 address of the Next-Next Hop object.

R2 computes ERs (Explicit Routes) of the IPv4 address selected as mentioned above through a CSPF (Constraint-based Shortest Path First) algorithm based on unicast routing. At this time, a session for a protected LSP should not be included.

R2 selects any route included in NHDB among the selected ERs with reference to the NHDB. For example, as the ER from R2 to R4, any one of routes R2→R10→R11→R4 and R2→R6→R7→R4 is selected, and particularly, R2→R6→R7→R4 having a session matched with the NHDB is selected.

R2 transmits a Path message to R6 based on the selected ER. The Path message transmitted from R2 to R6 includes the same information as the Path message of the protected LSP which is transmitted from R2 to R3, and a Unicast Backup LSP Request object. When R2 receives the Resv message from R6, R2 transmits the Path message for setup of the backup LSP to R6. Thereafter, when a Path Refresh message is received from R1, R2 transmits the Path message to R6 together with the Unicast Backup LSP Request object.

The router receiving the Path message in which the Unicast Backup LSP Request object is included computes the ER routed to an end point in such a method as performed at the PLR, and determines a direction of the LSP with reference to the NHDB of R6.

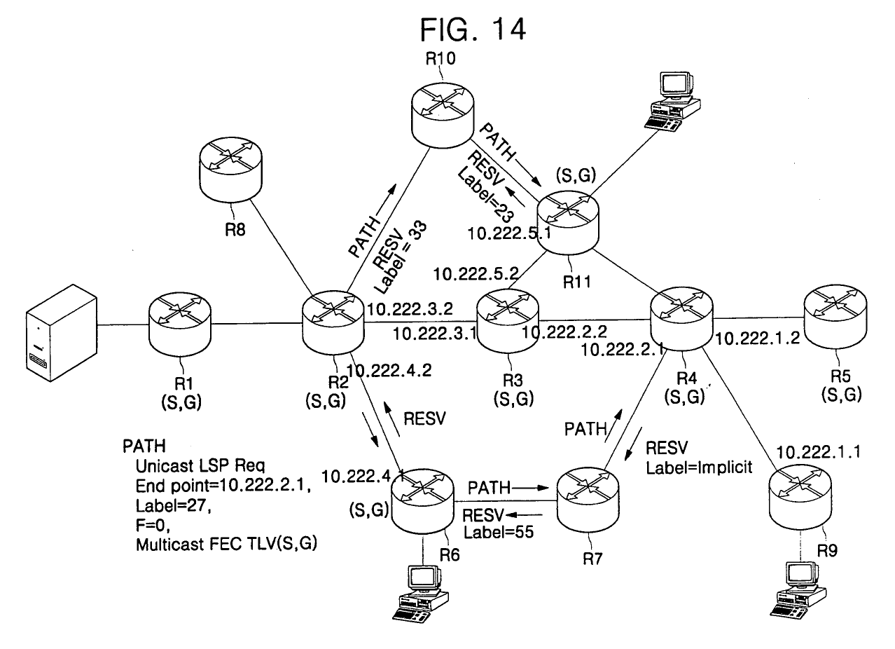

FIG. 14 shows setup of a backup LSP (Label-Switched Path) of MPLS multicast.

In FIG. 14, when a Unicast Backup LSP Request object is included in a Path message received from R2, R6 computes ERs applying a CSPF (Constraint-based Shortest Path First) to an end point address within the Unicast Backup LSP Request object. R6 determines a direction of the Path message with reference to an NHDB with respect to computed ERs. Since there is no NHDB for R4, R6 may transmit the Path message with reference to the Unicast Backup LSP Request object, or include the computed ERs in an Explicit Router object of the Path message.

In FIG. 14, R6 can recognize that a corresponding multicast S,G should be transmitted to a unicast backup LSP using a label, a multicast source address and a multicast group address which are within the Unicast Backup LSP Request object, and can recognize label information to be swapped. In the multicast S,G, the symbol “S” denotes a source and “G” denotes a group.

In FIG. 14, the ER from R2 to R11 is R2→R10→R11 and has no session included in the NHDB. Hence, setup of the path of R2→R10→R11 is performed according to a method of setting up an existing unicast LSP.

When R2 detects a failure of the network, R2 notifies R6 that the failure occurs in order to transmit packets to the backup LSP. The failure can be detected through exchange of a Hello message between routers. A Unicast Backup LSP (Label Switched Path) Request object is used, wherein an “F” flag should be set.

When receiving the Unicast Backup LSP (Label Switched Path) Request object set by the “F” flag, R6 checks whether a backup LSP is established or not. If the backup LSP is established, R6 transmits a packet to the corresponding backup LSP. However, if the backup LSP is not established, R6 attempts to establish the unicast backup LSP.

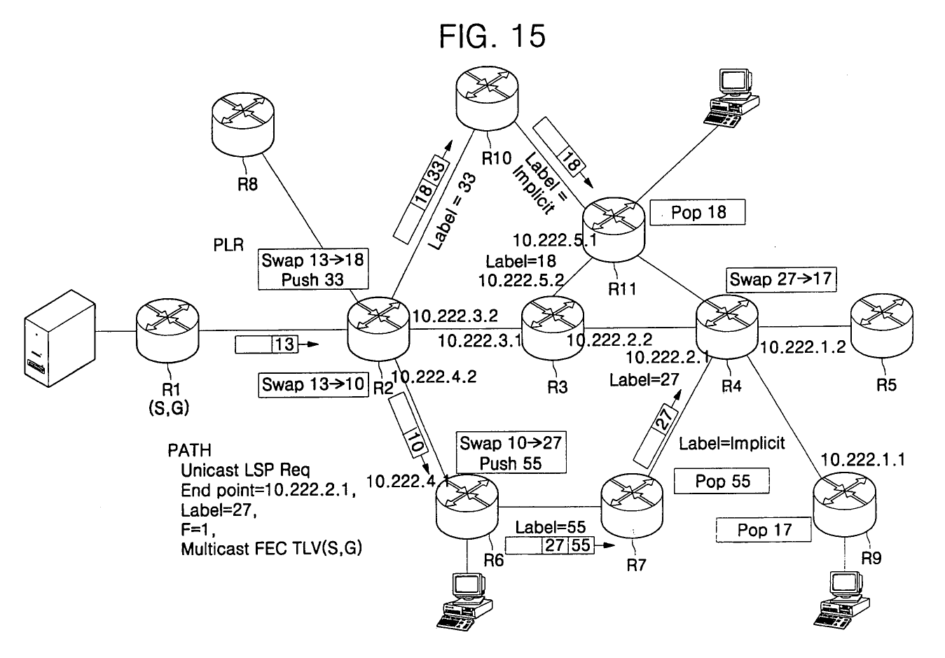

R6 transmits the MPLS multicast packet to the established backup LSP. This process will be described with reference to FIG. 15.

FIG. 15 shows transmission of an MPLS multicast packet to which fast rerouting is applied, wherein the transmission is performed through the backup LSP set up in FIG. 14.

In FIG. 15, R2 transmits an existing multicast packet to R6. R6 transmits the packet by swapping a label with a label which R4 allocates to a corresponding multicast group and by pushing a label for a unicast backup LSP. In other words, R6 transmits the packet to R7 after swapping a label 10 of the packet with a label 27. R4 can transmit the received packet to R9 with reference to an existing label table.

The path between R10 and R11 can be used in the case where packet transmission between R2 and R4 is not performed through R6 and R7 and must be performed through R10 and R11. Since no multicast tree is present in an existing direction of R10, R 11 transmits the packet using a packet transmission method for existing unicast fast rerouting. Thus R2-R4-R7-R4 and R2-R10-R11-R4 are both considered as detour routes for the path R2-R3-R4.

As set forth above, the present invention establishes the NHDB having a tree structure where each router takes on the basis of itself using the extended signaling protocol, and determines the LSPs for fast rerouting of MPLS multicast with reference to the established NHDB. When a failure occurs and thus a packet is transmitted through a backup path, a protected LSP and a backup LSP overlap a path for transmitting an existing multicast packet, the packet is transmitted in a multicast format with respect to the overlapping path, so that it is possible to prevent the overlapping message from being transmitted and to perform efficient MPLS multicast rerouting.

According to the present invention, it is possible to rapidly cope with a network failure through fast rerouting in the MPLS multicast.

Although exemplary embodiments of the present invention have been described, it will be understood by those skilled in the art that the present invention should not be limited to the described exemplary embodiments. Rather, various changes and modifications can be made within the spirit and scope of the present invention, as defined by the following claims.

What is claimed is:

1. A fast rerouting apparatus for multiprotocol label switching (MPLS) multicast, comprising:
a message sender for sending and receiving a message to and from an upstream or downstream node;
a message processor for, when a path requested for routing through a routing request message from the upstream node is a path to perform fast rerouting, sending the routing request message for establishing a Next Hop database (NHDB) to the downstream node through the message sender, and establishing the Next Hop database (NHDB) using information included in a response message received from the downstream node; and
a storage for storing the established Next Hop database (NHDB).

2. The fast rerouting apparatus of claim 1, wherein checking whether the corresponding path is a path requested for the fast rerouting or not is performed using session information of the corresponding path requested for the fast rerouting.

3. The fast rerouting apparatus of claim 1, wherein the Next Hop database (NHDB) includes information on network addresses and labels of a next downstream node and a next-next downstream node.

4. The fast rerouting apparatus of claim 3, wherein the network address information is IPv4 address information.

5. The fast rerouting apparatus of claim 1, wherein information used for establishment of the Next Hop database (NHDB) is transmitted through a Next Hop object and a Next-Next Hop object of a resource reservation protocol-traffic engineering (RSVP-TE) protocol received from the downstream node.

6. The fast rerouting apparatus of claim 5, wherein the Next Hop object includes information on a network address and a label of the next downstream node.

7. The fast rerouting apparatus of claim 5, wherein the Next-Next Hop object includes information on a network address and a label of the next-next downstream node.

8. The fast rerouting apparatus of claim 1, further comprising a path computer for computing and determining a path with reference to the established Next Hop database (NHDB).

9. The fast rerouting apparatus of claim 8, wherein the path computer obtains information on a destination network address of a backup path from the Next Hop database (NHDB), and obtains routing information routed to the network address using a constraint-based shortest path first (CSPF).

10. A protocol for fast rerouting for multiprotocol label switching (MPLS) multicast, the protocol comprising:
a Next Hop object including information for establishing a Next Hop database (NHDB) used when a path for the fast rerouting of the MPLS multicast is established;
a Next-Next Hop object including information for establishing the Next Hop database (NHDB); and
a Unicast Backup LSP (Label Switched Path) Request object requesting another node of a corresponding multicast tree to set up a unicast backup path.

11. The protocol of claim 10, wherein the Next Hop object includes information on a network address and a label of a next downstream node.

12. The protocol of claim 10, wherein the Next-Next Hop object includes information on a network address and a label of a next-next downstream node.

13. The protocol of claim 10, wherein the Unicast Backup LSP Request object includes information on an end point network address of a tunnel used for setup of the unicast backup path, information on a label allocated to a corresponding multicast group address at the end point, information on a multicast source address to be transmitted to the tunnel, and information on a multicast group address to transmitted to the tunnel.

14. A fast rerouting apparatus for multiprotocol label switching (MPLS) multicast on a MPLS network where a replacement path for fast rerouting for the MPLS multicast, the fast rerouting apparatus comprising:
a message sender for sending and receiving a message to and from an upstream and downstream node;
a failure detector for determining whether a failure occurs between the downstream node and another node or not;
a path computer for searching the replacement node of the node where the failure occurs; and
a packet processor for determining whether a multicast packet received from the upstream node is a packet which must be transmitted through both the path where the failure occurs and the replacement path, and when the multicast packet must be transmitted through both of the paths, transmitting the multicast packet to a next branch node in a multicast packet format, and setting up a unicast backup path from the next branch node to a destination node of the packet.

15. The fast rerouting apparatus of claim 14, wherein the path computer sets up the unicast backup path from the next branch node to the destination node of the packet by transmitting a message requesting a Unicast Backup LSP (Label Switched Path) Request object to the branch node through the message sender.

16. The fast rerouting apparatus of claim 14, wherein the failure detector determines whether the failure occurs or not through exchange of a Hello message with a neighboring node.

17. The fast rerouting apparatus of claim 16, wherein the failure detector determines that the failure occurs between the neighboring node and a corresponding node when no message is received from the neighboring node in excess of a predetermined reference time.

18. The fast rerouting apparatus of claim 14, wherein the failure occurs at a link connecting with the downstream node or at the downstream node.

19. A fast rerouting method for multiprotocol label switching (MPLS) multicast, comprising:
a first step of receiving information for establishing a Next Hop database (NHDB) used for fast rerouting on a network from a downstream node;
a second step of establishing the Next Hop database (NHDB) using the received information; and
a third step of establishing a path for the fast rerouting for the MPLS multicast using the established Next Hop database (NHDB).

20. The fast rerouting method of claim 19, wherein information for establishment of the Next Hop database (NHDB) is received through a Next Hop object and a Next-Next Hop object received from the downstream node.

21. The fast rerouting method of claim 19, wherein the Next Hop database (NHDB) includes information on network addresses and labels of a next downstream node and a next-next downstream node.

22. The fast rerouting method of claim 19, wherein in the third step, the establishment of the path is performed using a constraint-based shortest path first (CSPF).

23. A fast rerouting method for multiprotocol label switching (MPLS) multicast on a network where a backup path for fast rerouting for the MPLS multicast used is established using a Next Hop database (NHDB), the fast rerouting method comprising:
a first step of detecting generation of a failure on a protected path;
a second step of searching the backup path of the protected path where the failure occurs;
a third step of determining whether the backup path belongs to existing transmission path of a multicast packet received from an upstream node or not; and
a fourth step of transmitting the multicast packet to a next branch node on the backup path belonging to the existing transmission path in a multicast packet format, and requesting the branch node to establish a unicast backup path from the branch node to an end node of the backup node.

24. The fast rerouting method of claim 23, wherein the established unicast backup path is a path selected by using an Unicast Backup LSP (Label Switched Path) Request object and a constraint-based shortest path first (CSPF).
